(19) United States
(12) Patent Application Publication
(10) Pub. No.: US 2026/0309598 A1
(43) Pub. Date: Oct. 8, 2026

(54) SYSTEMS AND METHODS FOR DETERMINING COMPACTION OF A THIN FILM BASED ON IMPEDANCE

(71) Applicant: UNIVERSITY OF SOUTHERN CALIFORNIA, Los Angeles, CA (US)

(72) Inventors: Weijian Ding, Los Angeles, CA (US); Amy Childress, Los Angeles, CA (US); Kexin Ma, Los Angeles, CA (US)

(21) Appl. No.: 19/186,137

(22) Filed: Apr. 22, 2025

Related U.S. Application Data
(60) Provisional application No. 63/638,180, filed on Apr. 24, 2024.

(51) Int. Cl. G01N 3/06; G01N 3/08

(52) U.S. Cl. CPC G01N 3/066; G01N 3/08; G01N 2203/0282

(57) ABSTRACT

Disclosed herein are devices, methods, and systems to quantify the compaction of thin films.

### CROSS-REFERENCE TO RELATED APPLICATION

This application claims priority to and benefit of U.S. provisional patent application No. 63/638,180 filed Apr. 24, 2024, which is fully incorporated by reference.

### GOVERNMENT SUPPORT CLAUSE

This invention was made with government support under grant number 1820389 awarded by the National Science Foundation (NSF) and Cooperative Agreement (W9132T-23-2-0002) with the U.S. Army Corps of Engineers, Engineer Research and Development Center, and Construction Engineering Research Laboratory (USACE ERDC-CERL). The government has certain rights in the invention.

### BACKGROUND

Thin-film materials play critical roles in applications pertaining to water treatment, electronics, medicine, and power generation and storage. Thin-film materials are characterized by one dimension (typically the thickness) being significantly smaller (at least twenty times smaller, and often hundreds of times smaller) than their other two dimensions. For example, in the water treatment industry, thin-film materials are used in drinking water supply, wastewater reuse, and desalination; in electronics, for semiconductor devices, telecommunications, and photoconductors; in medicine, for drug delivery, hemodialysis, and artificial organs; and in power generation and storage, for thin-film solar panels and fuel cells.

Membrane, as a specialized class of thin films engineered for selective mass transfer, play a crucial role in a variety of water treatment applications like seawater desalination, wastewater treatment, potable water reuse, and resource recovery. When pressure is applied to thin-film materials during use or during manufacturing, the thin-film material often undergoes compaction. For water treatment membranes, a hydraulic pressure differential results in membrane compaction that can decrease performance and limit the practical use of the membrane. In pressure-driven applications (e.g., ultrafiltration, nanofiltration, and reverse osmosis), compaction changes the membrane morphology and internal structure and can cause decreased water flux, higher energy consumption, and lower salt rejection. In thermally driven applications (e.g., membrane distillation), membrane compaction results in increased heat loss and reduced water permeability.

Compaction can occur instantly or over longer time periods and, depending on the recovery properties of the membrane, can cause irreversible, partially reversible, or reversible changes in membrane morphology and mechanical properties. The recovery properties of a membrane are often characterized by creep-recovery measurements, whereby the membrane is exposed to long-term compressive stress (causing time-dependent deformation) and then is allowed to recover. Recovery can also be characterized by hysteresis curves, whereby the membrane is exposed to repeated loading and unloading forces.

Measuring deformation due to creep separately from deformation due to instant compaction is essential to distinguish the effects of sudden pressure changes versus the effects of long-term compressive stress on membrane performance and resiliency in water treatment applications. For example, in nanofiltration and reverse osmosis processes, the membranes are usually precompacted by instant force for a short time period to prevent early flux decline and provide stable flux during normal operation; however, over the longer-term operation, the performance of these membranes can still be impacted by creep.

In past studies, scanning electron microscopy (SEM) has been used to measure membrane thickness before and after compaction. Although SEM images are useful to visualize and quantify changes in membrane morphology and thickness, SEM images represent the membrane state after compaction and recovery and cannot distinguish the effects of compaction due to creep from the effects of instant compaction.

Studies of water treatment membranes have also used mechanical testing to characterize compaction. Using dynamic mechanical analysis (DMA), material elongation due to shear strain has been used to represent the compaction of homogeneous membranes. However, if membranes are not homogeneous, then compaction cannot be represented by material elongation. Also, for water treatment membranes with low stiffness, compaction cannot be measured by DMA because the membrane cannot support the load of the clamp during measurements. Severe noise is typically observed and prevents the acquisition of meaningful data. Thus, systems and methods to measure the compaction of thin films, such as water treatment membranes, are desired to overcome challenges in the art, some of which are described herein.

### SUMMARY

Described herein are devices, systems, and methods to quantify the compaction of thin films.

In one aspect, a system for determining compaction of a thin film based on measured impedance across the thin film is disclosed. One embodiment of the system comprises a force application and measurement device, wherein force is applied to the thin film by a force application and measurement device. Further comprising the system is an impedance meter connected to two electrodes, with each of the electrodes located on opposite sides of the thin film. The force application and measurement device applies a precisely controlled force to the thin film in a temperature-controlled environment, and the impedance meter detects in real-time a cross-material impedance at a set frequency. For example, the set frequency may be between 1-1000 kHz. In some instances, the impedance meter may be an electrochemical impedance spectroscopy (EIS) meter.

In some instances of the system, force is applied to the thin film by the force application and measurement device using one or more plates that apply the force to one or both sides of the thin film. In various instances, the force application and measurement device applies mechanical force to the thin film using one or more of hydraulics, pneumatics, motor-drive, magnetics, electro-magnetics, and the like.

In some instances, the system further comprises a computer having one or more processors and a memory. The force application and measurement device and the impedance meter are connected to the computer such that the computer can transmit information to the force application and measurement device and/or the impedance meter and/or receive information transmitted from the force application and measurement device and/or the impedance meter. For example, information transmitted to the force application and measurement device and/or the impedance meter from the computer may include control signals for controlling the force application and measurement device and/or the impedance meter.

In another aspect, a method of determining a correlation between compaction and measured impedance across a thin film is disclosed. One embodiment of the method comprises compacting a thin film by applying a force; measuring compaction of the thin film based on a distance, d, from one side of the thin film to an opposite side; measuring an impedance of the compacted thin film; repeating the previous three steps a plurality of times, wherein each of the measured distances (d1, d2, . . . dn) caused by compaction are correlated with the measured impedance at each distance; and creating a table that correlates the measured distance, d, (associated with compaction, as d decreases with increasing compaction) with an impedance value such that measured impedance across the thin film can be correlated with a level of compaction.

Another embodiment of the method of determining a correlation between compaction and measured impedance across a thin film comprises measuring impedance from one side of the thin film to an opposite side of the thin film in an un-compacted state; applying a force to the thin film to compact the thin film; measuring an impedance of the compacted thin film; repeating the previous three steps a plurality of times, wherein compaction of the thin film is correlated with the measured impedance.

Another aspect comprises a system for monitoring compaction of a thin film. One embodiment of the system comprises an impedance meter connected to at least two electrodes, with each of the electrodes located on opposite sides of the thin film; and a computing device comprising at least one or more processors and a memory, wherein the computing device is in communication with the impedance meter and where a table is stored in the memory, the table correlates impedance values with compaction. The computing device receives an impedance value from the impedance meter, the impedance value indicating a real-time value of impedance across the thin film and determines a real-time compaction value of the thin film based on the impedance value received from the impedance meter and the table stored in the memory.

In some instances of the system, the computing device causes an action to occur if the determined real-time compaction value meets or exceeds a threshold value. For example, the action may comprise one or more of triggering an alarm, causing a back-flow through the thin film, diverting a fluid flow away from the thin film, and/or shutting down a system until the thin film is replaced or cleaned, and the like.

Another aspect comprises a method for monitoring compaction of a thin film. One embodiment of the method comprises receiving an impedance value, the impedance value indicating a real-time value of impedance across the thin film and determining a real-time compaction value of the thin film based on the received impedance value received from the impedance meter and a table correlating impedance values with compaction.

In some instances of the method, the computing device causes an action to occur if the determined real-time compaction value meets or exceeds a threshold value. For example, the action may comprise one or more of triggering an alarm, causing a back-flow through the thin-film, diverting a fluid flow away from the thin film, and/or shutting down a system until the thin film is replaced or cleaned, and the like.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1A illustrates an exemplary system for determining the compaction of a thin film based on measured impedance across the thin film.

FIG. 1B illustrates an alternate system for determining the compaction of a thin film based on measured impedance across the thin film.

FIGS. 2A and 2B are exemplary flowcharts illustrating processes for determining a correlation between compaction and measured impedance across the thin film.

FIG. 3A is an exemplary table showing a correlation between the measured distance, d, (associated with compaction, as d decreases with increasing compaction) with an impedance value.

FIG. 3B is an exemplary table showing a correlation between the measured impedance with a compaction value.

FIG. 4A is an illustration of a system for monitoring the compaction of a thin film once a correlation between impedance across the thin film and impedance has been established.

FIG. 4B illustrates an exemplary flowchart for a process of monitoring the compaction of a thin film once a correlation between impedance across the thin film and impedance has been established.

FIG. 5 illustrates an example computing device upon which embodiments of the invention may be implemented.

FIG. 6 illustrates a schematic of a measurement system used to measure thin film compaction where stable force and temperature control are provided by dynamic mechanical analysis and real-time cross-membrane impedance is detected by electrochemical impedance spectroscopy, providing quantification of membrane compaction.

FIG. 7 illustrates continuous creep testing with stepwise pressure increases from 1 to 12.5 psi over a 3 h period. The pressure was then released (dropped to 0 psi). The table embedded in the graph shows percentages of creep/total compaction, instant/total compaction, and creep/instant compaction for each creep step. The creep/instant compaction ratio increases from 2.4 to 49% from steps 1 to 6. The average irrevocable compaction is 16%.

FIG. 8A illustrates the hysteresis of a sample membrane demonstrated through strain hysteresis detected by dynamic mechanical analysis and FIG. 8B illustrates the hysteresis of the sample membrane demonstrated through impedance hysteresis detected by electrochemical impedance spectroscopy. Comparison of the average irrevocable strain (2.9%) with the average irrevocable impedance difference (2.7%) provides validation of the disclosed methods.

FIG. 9A illustrates a scanning electron microscope image for a pristine sample membrane and FIG. 9B illustrates the compacted sample membrane imaged in a fully recovered state after compaction under 4 psi pressure. The thickness percent difference of the compacted membrane compared with the pristine membrane is approximately 2.6%.

FIG. 10A illustrates a scanning electron microscopy (SEM) image of a polyester (PE) backing layer with void spaces. FIG. 10B illustrates a schematic of the PE backing layer showing the void space, solid material areas, and their representative thicknesses.

FIG. 11A illustrates the SEM image of the cross-sectional morphology of the pristine nanofiltration (NF) membrane. FIG. 11B illustrates the SEM image of the cross-sectional morphology of the NF membrane tested under 80 psi pressure. FIG. 11C illustrates the SEM image of the cross-sectional morphology of the NF membrane tested under 300 psi pressure. Air pockets were observed clearly in the pristine membrane, but collapsed and were less visible during compaction, especially at 300 psi.

FIG. 11D illustrates the corresponding values of layer/component and total membrane thickness for the pristine NF membrane. FIG. 11E illustrates the corresponding values of layer/component and total membrane thickness for the NF membrane tested under 80 psi pressure. FIG. 11F illustrates the corresponding values of layer/component and total membrane thickness for the NF membrane tested under 300 psi pressure.

FIG. 11G illustrates the relative thickness of the NF membrane layers/components. FIG. 11H illustrates the relative compaction of the NF membrane layers/components. The greatest compaction occurred in the PE void spaces, even though this component only accounted for 14% of the total pristine membrane thickness.

FIG. 12A illustrates the SEM image of the cross-sectional morphology of the pristine reverse osmosis (RO) membrane. FIG. 12B illustrates the SEM image of the cross-sectional morphology of the RO membrane tested under 80 psi pressure. FIG. 12C illustrates the SEM image of the cross-sectional morphology of the RO membrane tested under 300 psi pressure. Semicontinuous air pockets were observed clearly in the pristine membrane, but they become disjointed and less visible during compaction.

FIG. 12D illustrates the corresponding values of layer/component and total membrane thickness for the pristine RO membrane. FIG. 12E illustrates the corresponding values of layer/component and total membrane thickness for the RO membrane tested under 80 psi pressure. FIG. 12F illustrates the corresponding values of layer/component and total membrane thickness for the RO membrane tested under 300 psi pressure.

FIG. 12G illustrates the relative thickness of the RO membrane layers/components. FIG. 12H illustrates the relative compaction of the RO membrane layers/components. The greatest compaction occurred in the PE solid material, which further compacted at 300 psi to counterbalance the applied pressure.

FIG. 13A illustrates the normalized impedance across seven creep-and-recovery cycles for the NF membrane under 80 psi pressure. FIG. 13B illustrates the normalized impedance across seven creep-and-recovery cycles for the RO membrane under 200 psi pressure. Each cycle lasted 24 h with 8 h of creep and 16 h of recovery. The gradual occurrence of creep shows the development of membrane fatigue, leading to a final irrevocable compaction of 5.1% for the NF membrane and 5.0% for the RO membrane.

FIG. 14 illustrates the normalized and corresponding compaction of pristine and aged RO membrane samples under 200 psi pressure for 10 min. Membrane samples were aged by exposing them to UV radiation for 4, 6, 24, 48, 72 h. RO membrane deformation (compaction) increased with the duration for which the samples were exposed to UV radiation due to the development of membrane fatigue.

FIG. 15A illustrates the creep-and-recovery behavior with incrementally increasing pressure for the NF membrane, with stepwise pressure increasing from 10 to 80 psi for steps 1-8. FIG. 15B illustrates the creep-and-recovery behavior with incrementally increasing pressure for the RO membrane, with stepwise pressure increasing from 80 to 150 psi for steps 1-8 and increasing from 200 to 250 psi for steps 9-10. Each step lasted 1 h. For both membranes, the role of instantaneous compaction decreased, and the role of creep increased with each step.

FIG. 16A illustrates the hysteresis of the NF membrane through strain hysteresis detected by dynamic mechanical analysis. FIG. 16B illustrates the hysteresis of the NF membrane through impedance hysteresis detected by a potentiostat. Comparison of the average irrevocable strain (2.2%) with the average irrevocable impedance difference (2.6%) provided in-situ method validation.

FIG. 17A illustrates the hysteresis of the RO membrane through strain hysteresis detected by dynamic mechanical analysis. FIG. 17B illustrates the hysteresis of the RO membrane through impedance hysteresis detected by a potentiostat. Comparison of the average irrevocable strain (7.8%) with the average irrevocable impedance difference (5.6%) provided in-situ method validation.

FIG. 18A illustrates the SEM image of the pristine NF membrane in a fully recovered state after the hysteresis experiment with 80 psi applied pressure. FIG. 18B illustrates the SEM image of the compacted NF membrane in a fully recovered state after the hysteresis experiment with 80 psi applied pressure. The thickness percent difference of the compacted membrane compared with the pristine membrane was 3.4%.

FIG. 19A illustrates the SEM image of the pristine RO membrane in a fully recovered state after the hysteresis experiment with 200 psi applied pressure. FIG. 18B illustrates the SEM image of the compacted RO membrane in a fully recovered state after the hysteresis experiment with 200 psi applied pressure. The thickness percent difference of the compacted membrane compared with the pristine membrane was 5.2%.

FIG. 20A illustrates the compaction measured by compressive tests and elongation measured by tensile tests for the NF membrane. FIG. 20B illustrates the compaction measured by compressive tests and elongation measured by tensile tests for the RO membrane.

FIG. 20C illustrates the compaction measured by compressive tests and elongation measured by tensile tests for a low-pressure membrane. Average compaction was greater than average elongation for the multilayer, heterogeneous membranes and more so for the single-layer, homogeneous membrane.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure.

As used in the specification and the appended claims, the singular forms “a,” “an” and “the” include plural referents unless the context clearly dictates otherwise. For example, a referral to a thin film includes reference to more than one thin film. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of”′ and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

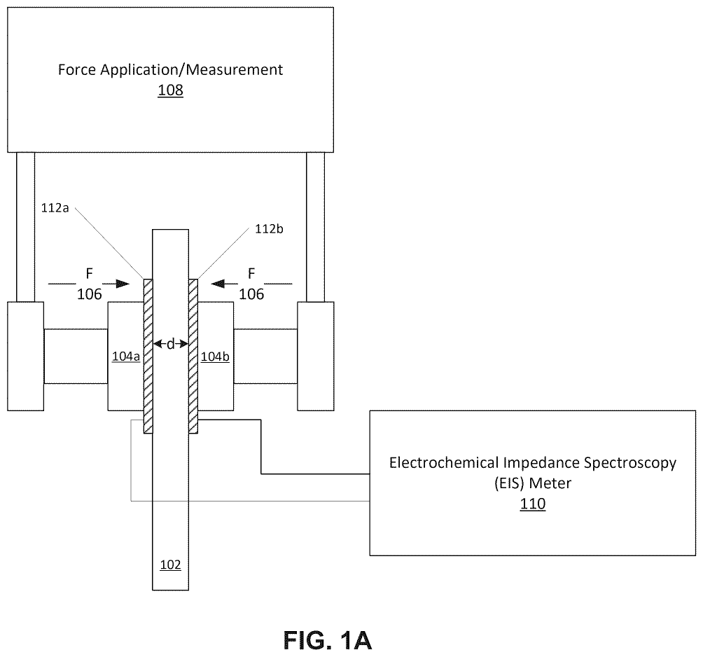

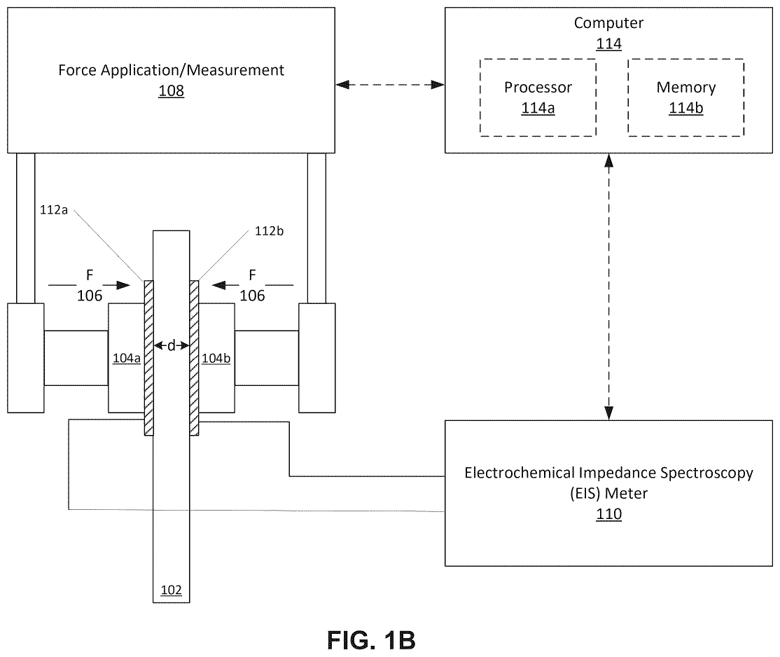

FIG. 1A illustrates an exemplary system for determining compaction of a thin film 102 (e.g., water treatment membrane, ion-exchange membrane, artificial organ, etc.), and these membranes are usually comprised of polytetrafluoroethylene, polyvinylidene fluoride, and/or polyethylene) based on measured impedance across the thin film 102. As shown in FIG. 1, force 106 is applied to the thin film by a force application and measurement device 108. For example, force 106 may be applied to the thin film 102 using a mechanical analyzer (e.g., DMA 850, TA Instruments, New Castle, DE). Force 106 is applied to the thin film 102 using one or more plates 104a, 104b that apply the force 106 to one or both sides of the thin film 102. The use of plates 104a, 104b is just an example of applying force to the thin film 102 and other devices and methods of applying such force are contemplated within the scope of this disclosure. The force application and measurement device 108 applies mechanical force to the thin film 102 using hydraulics, pneumatics, motor-drive, magnetics, electro-magnetics, or any other way of applying a controlled mechanical force to the thin film 102. Further comprising the system of FIG. 1A is an impedance meter 110 connected to two electrodes 112a, 112b, with each of the electrodes 112a, 112b located on opposite sides of the thin film 102.

In some instances, the impedance meter 110 may comprise a potentiostat (such as Model SP-150e, BioLogic Science, Knoxville, TN), and the electrodes 112a, 112b may comprise a pair of custom-fabricated electrodes comprised of copper with gold surface coating. In other instances, the electrodes 112a, 112b may be comprised of other conductive materials. In some instances, the impedance meter 110 may comprise an EIS meter. The force application and measurement device 108 applies a precisely controlled force to the thin film 102 in a temperature-controlled environment, and the impedance meter 110 detects the real-time cross-material impedance at a set frequency (e.g., 1-1000 kHz).

Generally, compaction of the thin film 102 will cause the distance, d, from one side of the thin film 102 to the other to decrease with a corresponding decrease in impedance from one side of the thin film 102 to the other. The distance, d, can be correlated with impedance values. Compaction of the thin film 102 can be determined by changes in the measured impedance across the thin film over time caused by the compaction.

FIG. 1B illustrates an alternate system for determining compaction of a thin film 102 based on measured impedance across the thin film 102. As shown in FIG. 1B, the force application and measurement device 108 and the impedance meter 110 are connected to a computer 114. Such a connection may be wired (including fiber optic), wireless, or combinations thereof. The computer 114 comprises at least one or more processors 114a and a memory 114b. the computer 114 can transmit information to the force application and measurement device 108 and/or the impedance meter 110 and/or receive information transmitted from the force application and measurement device 108 and/or the impedance meter 110. Such information may include control signals for controlling the force application and measurement device 108 and/or the impedance meter 110.

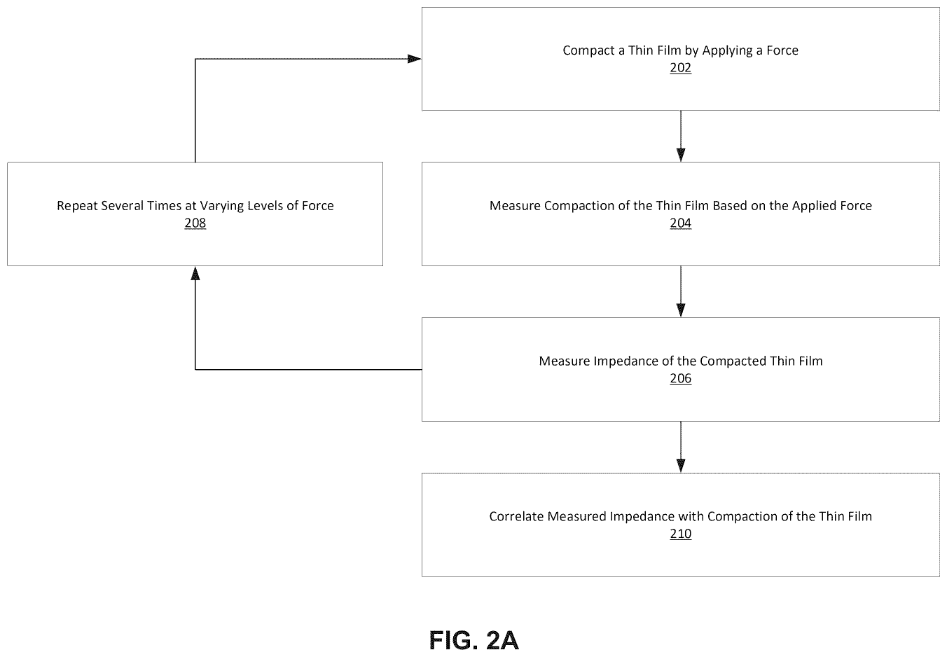

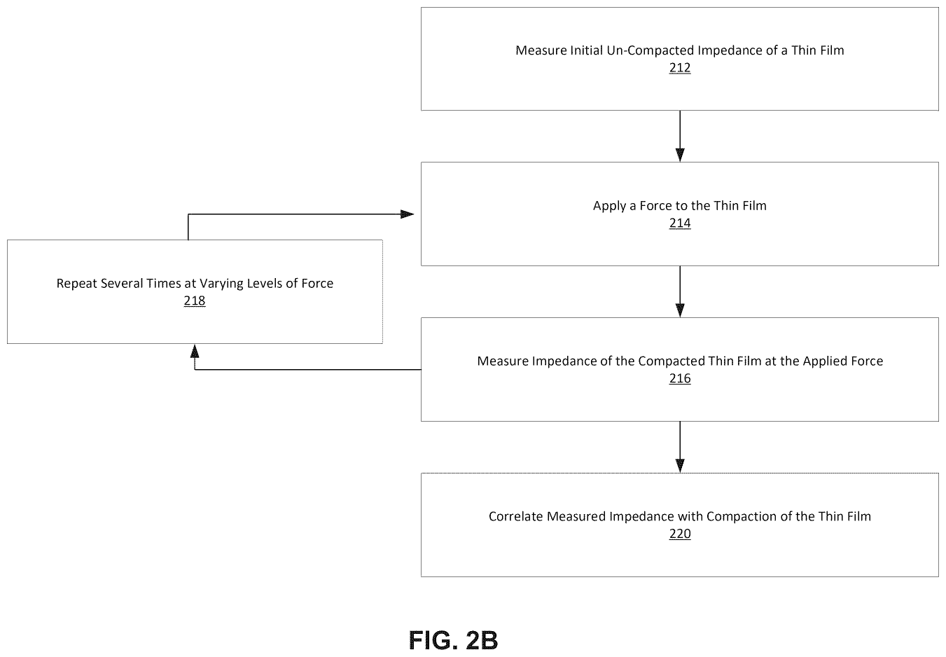

The systems shown in FIGS. 1A and 1B provide a correlation between compaction and measured impedance across the thin film 102. Examples of the process of determining this correlation are shown in the exemplary flowcharts of FIGS. 2A and 2B. In FIG. 2A, at 202, a thin film is compacted by applying a force. For example, this force may be applied by a force application and measurement device 108, as described herein. At 204, compaction of the thin film caused by the applied force is measured. This may be measured as a change in distance, d, from one side of the thin film to the other. The distance, d, may be measured using the force application and measurement device, as described herein, or by any other device capable of making such measurements. At 206, an impedance is measured of the compacted film at the applied force. The impedance measurement may be made by the impedance meter 110, as described herein. At 208, the process of applying a force to the thin film 202, measuring compaction 204, and then measuring impedance of the compacted thin film 206 is repeated a plurality of times. In this way, measured impedance across the thin film can be correlated with a level of compaction.

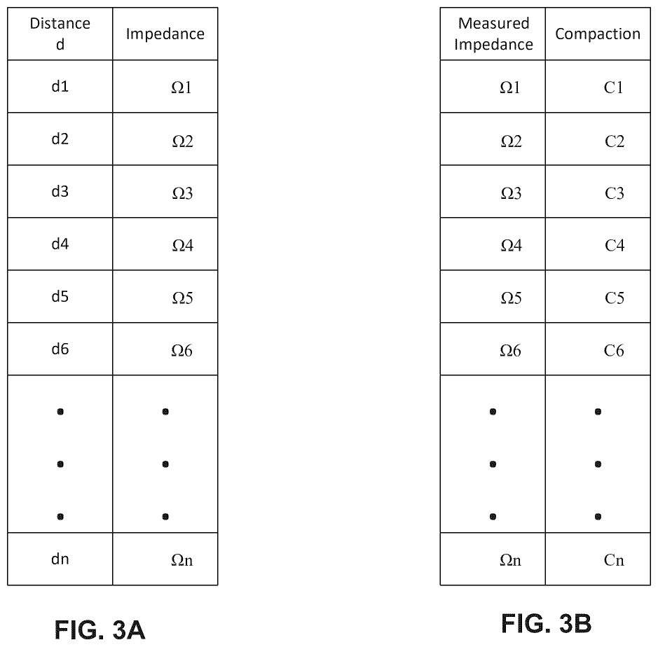

In FIG. 2B, at 212, the impedance of a thin film is measured in its un-compacted state (no or minimal force applied to the thin film). At 214, a force is applied to the thin film. For example, this force may be applied by a force application and measurement device 108, as described herein. At 216, an impedance is measured of the compacted film at the applied force. The impedance measurement may be made by the impedance meter 110, as described herein. At 218, the process of applying a force 212 to the thin film and measuring impedance 214 of the compacted thin film is repeated a plurality of times. At step 220, each of the measured impedances at the applied forces are correlated with compaction of the thin film In this manner, a table can be created such as that shown in FIG. 3B that correlates the measured impedance with a compaction value. In this way, measured impedance across the thin film can be correlated with a level of compaction.

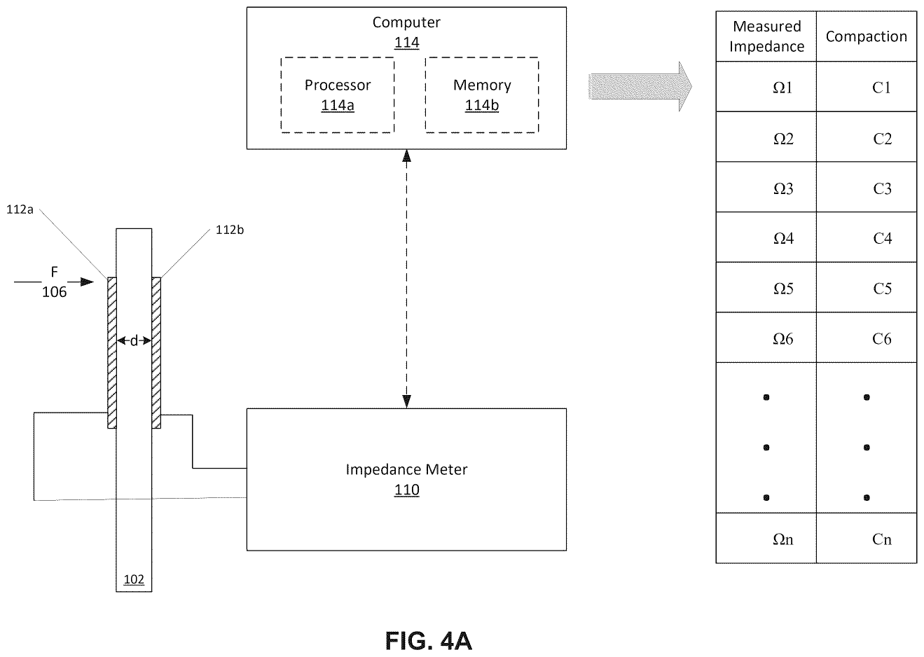

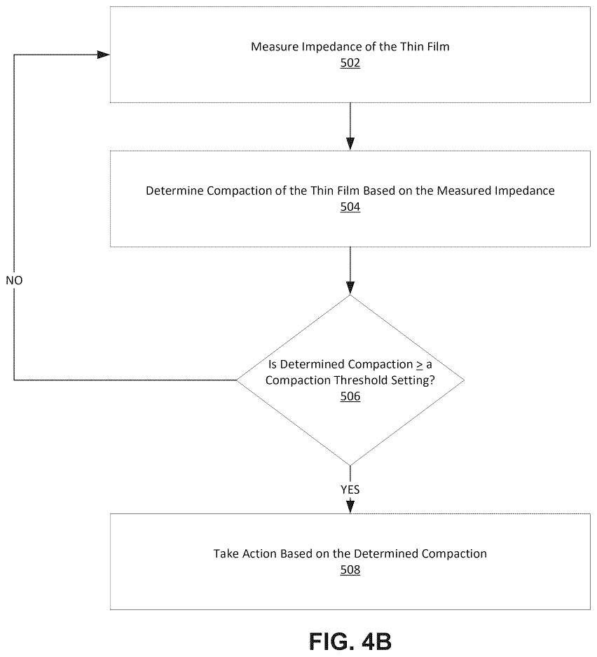

FIG. 4A is an illustration of a system for monitoring compaction of a thin film 102 once a correlation between impedance across the thin film 102 and compaction has been established. As shown in FIG. 4A, an impedance meter 110 is connected to two electrodes 112a, 112b, with each of the electrodes 112a, 112b located on opposite sides of the thin film 102. Force 106 applied to the thin film 102 (for example, a fluid being filtered through the thin film 102) causes compaction of the thin film 102, thus decreasing the distance, d, from one side of the thin film 102 to the other and/or otherwise compacting the thin film 102. This compaction is monitored by monitoring the impedance across the thin film using the impedance meter 110. The measured impedance is provided to a computer 114 comprising at least one or more processors 114a and a memory 114b. Because a correlation has been established between impedance values and compaction (see FIG. 3B), which can be stored in the memory 114b, the compaction or the thin film 102 can be determined by the one or more processors 114a based on the measured impedance. It is to be appreciated that the one or more processors 114a and/or the memory 114b may comprise a portion of the impedance meter 110, a portion of the force application and measurement device 108, be a stand-alone device/system (e.g., computer 114), and/or comprise all or part of another system such as, for example, a control system.

FIG. 4B illustrates an exemplary flowchart for the process of monitoring compaction of a thin film 102 once a correlation between impedance across the thin film 102 and impedance has been established. At 502, the impedance across the thin film is measured. At 504, the measured impedance is used to determine compaction of the thin film based on the pre-established correlation between impedance and compaction, as described herein. At 506, it is determined whether the determined compaction is at or exceeds a compaction threshold. If, at 506, the measured compaction does not meet or exceed the compaction threshold, then the process returns to 502, where it continues to measure impedance of the thin film. If, at 506, the determined compaction does meet or exceed the compaction threshold, the process goes to 508, where an action is taken based on the determined compaction. Such an action may include, as examples, triggering an alarm, causing a back-flow through the thin-film, diverting a fluid flow away from the thin film, shutting down a system until the thin film is replaced or cleaned, etc.

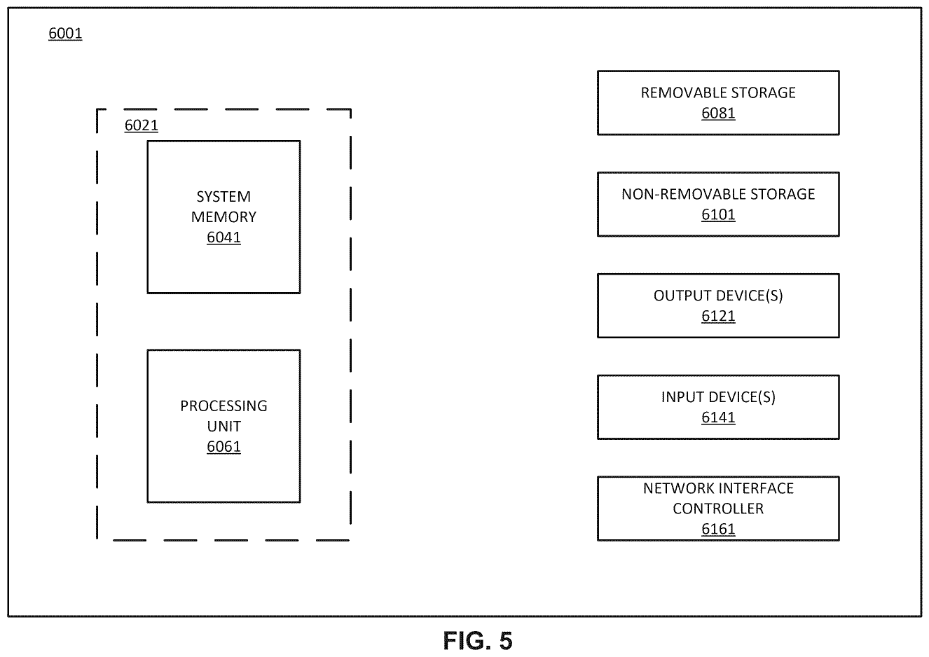

When the logical operations described herein are implemented in software, the process may execute on any type of computing architecture or platform. Such a computing device 6001 as shown in FIG. 5 can be the same as computing device 114, described above, or used alternatively for computing device 114. Furthermore, such a computing device 6001 as shown in FIG. 5 may comprise all or part of a network such as a cloud-based network. For example, referring to FIG. 5, an example computing device 6001 upon which embodiments of the invention may be implemented is illustrated. The computing device 6001 can optionally be a mobile computing device such as a laptop computer, a tablet computer, a mobile phone and the like. The computing device 6001 may include a bus or other communication mechanism for communicating information among various components of the computing device 6001. In its most basic configuration, computing device 6001 typically includes one or more processing units 6061 and system memory 6041. Depending on the exact configuration and type of computing device, system memory 6041 may be volatile (such as random-access memory (RAM)), non-volatile (such as read-only memory (ROM), flash memory, etc.), or some combination of the two. This most basic configuration is illustrated in FIG. 5 by dashed line 6021. Each of the one or more processing units 6061 may be a standard programmable processor that performs arithmetic and logic operations necessary for operation of the computing device 6001.

Computing device 6001 may have additional features/functionality. For example, computing device 6001 may include additional storage such as removable storage 6081 and non-removable storage 6101 including, but not limited to, magnetic or optical disks or tapes. Computing device 6001 may also contain network connection(s) 6161 that allow the device to communicate with other devices. Computing device 6001 may also have input device(s) 6141 such as a keyboard, mouse, touch screen, etc. Output device(s) 6121 such as a display, speakers, printer, etc. may also be included. The additional devices may be connected to the bus in order to facilitate communication of data among the components of the computing device 6001. All these devices are well known in the art and need not be discussed at length here.

The one or more processing units 6061 may be configured to execute program code encoded in tangible, computer-readable media. Computer-readable media refers to any media that is capable of providing data that causes the computing device 3001 (i.e., a machine) to operate in a particular fashion. Various computer-readable media may be utilized to provide instructions to the one or more processing units 6061 for execution. Common forms of computer-readable media include, for example, magnetic media, optical media, physical media, memory chips or cartridges, or any other non-transitory medium from which a computer can read. Example computer-readable media may include, but is not limited to, volatile media, non-volatile media and transmission media. Volatile and non-volatile media may be implemented in any method or technology for storage of information such as computer readable instructions, data structures, program modules or other data and common forms are discussed in detail below. Transmission media may include coaxial cables, copper wires and/or fiber optic cables, as well as acoustic or light waves, such as those generated during radio-wave and infra-red data communication. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the one or more processing units 6061 may execute program code stored in the system memory 6041. For example, the bus may carry data to the system memory 6041, from which the one or more processing units 6061 receive and execute instructions. The data received by the system memory 6041 may optionally be stored on the removable storage 6081 or the non-removable storage 6101 before or after execution by the one or more processing units 6061.

Computing device 6001 typically includes a variety of computer-readable media. Computer-readable media can be any available media that can be accessed by device 3001 and includes both volatile and non-volatile media, removable and non-removable media. Computer storage media include volatile and non-volatile, and removable and non-removable media implemented in any method or technology for storage of information such as computer readable instructions, data structures, program modules or other data. System memory 6041, removable storage 6081, and non-removable storage 6101 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 6001. Any such computer storage media may be part of computing device 6001.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROM s, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language, and it may be combined with hardware implementations.

The techniques described herein can optionally be at least partially implemented with a mobile computing device, such as a laptop computer, tablet computer or mobile phone. Accordingly, the mobile computing device is extremely small compared to conventional devices and is very portable, which allows the mobile computing device to be used wherever needed.

It should be appreciated that the logical operations described herein with respect to the various figures may be implemented (1) as a sequence of computer implemented acts or program modules (i.e., software) running on a computing device, (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

### EXAMPLES AND EXPERIMENTAL RESULTS

Described herein are experiments demonstrating the ability to detect membrane deformation by electrochemical impedance spectroscopy (EIS) with the ability to apply a precisely controlled force by DMA, thus providing a method to quantify the compaction of thin films such as water treatment membranes.

### Experiment #1

Linking EIS with DMA, short-term mechanical tests are performed across a range of temperatures and pressures to observe real-time compaction of the membrane. Creep, recovery, and hysteresis properties exhibited during longer-term mechanical tests are also analyzed. A creep/instant compaction ratio is introduced as an indicator of the contribution of creep to membrane compaction. Finally, the method is validated in two ways: with in situ hysteresis results by comparing the irrevocable strain with the irrevocable impedance difference and with ex situ thickness measurements by correlating the compaction observed in SEM images with that detected by the disclosed method.

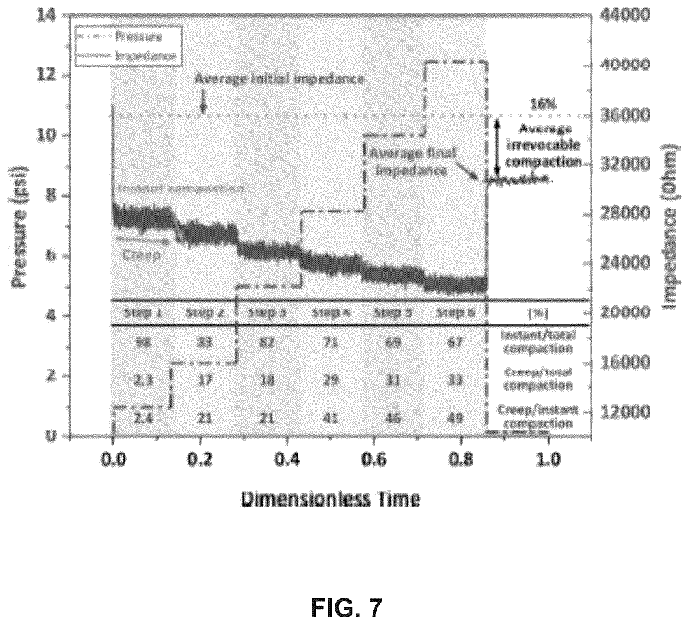

The exemplary measurement system (see FIG. 7) is comprised of a mechanical analyzer (DMA 850, TA Instruments, New Castle, DE), a potentiostat (Model SP-150e, BioLogic Science, Knoxville, TN), and a pair of laboratory fabricated electrodes. The mechanical analyzer was used to apply a precisely controlled force to a membrane in a temperature-controlled environment, and the potentiostat was used to detect the real-time cross-material impedance at a frequency of 100 KHz. This frequency was selected because it has been found that this frequency accurately describes the impedance change of a similar membrane. In this disclosed study, a commercial hydrophobic expanded polytetrafluoroethylene (ePTFE) membrane that is generally used for membrane distillation applications was tested. It is to be appreciated that other frequencies are contemplated within the scope of this disclosure.

For each experiment, a membrane coupon (approximately 15 mm×15 mm) was placed between the electrodes in the compaction clamps of the mechanical analyzer and a preload force was applied while initial impedance (Ω₀ in ohms) was measured. Preloading ensures that contact is maintained between the electrodes and the membrane surface. Subsequently, constant or sweeping temperatures and pressures were applied to the membrane, real-time temperatures and pressures were recorded, and the final impedance (Ω_{f} in ohms) was measured.

Compaction (%) was calculated from impedance percent difference (%) using compaction=impedance percent difference per Equation 1.

$$compaction = \frac{{Ω}_{0} - {Ω}_{f}}{{Ω}_{0}} \times 100 \% \qquad ( 1 )$$

The effects of the temperature and pressure on membrane compaction were measured in two sets of experiments; each set was repeated four times. In the first set, nine experiments were conducted at three temperatures (25, 45, and 65° C.) and three pressures (1, 5, and 10 psi). For each experiment, the initial impedance was measured, a force was applied for 10 min, the final impedance was measured, and the compaction was calculated.

The second set of experiments was conducted under dynamic conditions. In constant-pressure experiments, the surface pressure was kept at 5 psi, while the temperature was “swept” from 25 to 80° C. at a ramping rate of 5° C. min⁻¹. The duration of each experiment was approximately 12 min. Impedance was measured, and compaction was calculated the same as for the first set of experiments.

Continuous creep and recovery experiments were carried out following ASTM E139 (with a room temperature of 25° C.); experiments were repeated four times. The surface pressure was incrementally increased from 1 to 12.5 psi over a 3 h period. The first pressure increase was from 1 to 2.5 psi, and subsequently, pressure increases were 2.5 psi. The pressure was then released (dropped to 0 psi), and the membrane was allowed to relax and recover. Instant compaction (θ in %) was differentiated from compaction due to creep (ε in %). The creep/instant compaction ratio (φ) was then calculated to assess the contribution of creep to membrane deformation per Equation 2.

$$φ = \frac{ε}{θ} \qquad ( 2 )$$

Hysteresis experiments were conducted to further evaluate the membrane's ability to recover. A pressure-sweeping approach was used with a final pressure of 4 psi (representing a typical operating pressure for this membrane). In these experiments, the pressure was gradually increased from 0 to 4 psi at a ramping rate of 0.5 psi min⁻¹. Immediately thereafter, the pressure was decreased back to 0 psi at a buckling rate of 0.5 psi min⁻¹. This ramping and buckling process was repeated ten times per experiment, and experiments were repeated four times. Strain was measured as the pressure was increased to 4 psi and decreased back to 0 psi. The final strain values (when the pressure was returned to 0 psi) were averaged to determine the irrevocable strain. Similarly, the lowest (at maximum pressure) and final (when pressure was returned to 0 psi) impedance values were measured and the difference was calculated; the impedance difference values were averaged to determine the irrevocable impedance difference.

The method was validated using in situ hysteresis results and ex situ thickness measurements. First, the irrevocable strain measured by the DMA was compared with the irrevocable impedance difference measured by EIS. The difference between the irrevocable strain and the irrevocable impedance difference values indicates the method's accuracy.

Additionally, after the membrane coupon was removed from the compaction clamps, it was prepared for SEM imaging using a cryo-snap freeze-fracture method. The fractured membrane was then sputter-coated with nanocarbon to render the surface conductive. SEM images were obtained by using a scanning electron microscope (Nova NanoSEM 450, FEI, Hillsboro, OR). ImageJ software (version 1.51j8, National Institutes of Health, Bethesda, MD) was used to determine the membrane thickness in three locations on a sample; the average thickness for each sample was determined from three measurements. The thickness of the compacted membrane (dc in μm) was subtracted from the thickness of the pristine membrane (dp in μm) to calculate the thickness percent difference (%). Compaction (%) was calculated from thickness percent difference (%) per Equation 3.

$$Compaction = \frac{{d}_{p} - {d}_{c}}{{d}_{p}} \times 100 \% \qquad ( 3 )$$

This thickness percent difference was then compared with the impedance percent difference calculated from the impedance measurements. The difference between the two values provides an additional indicator of the method's accuracy.

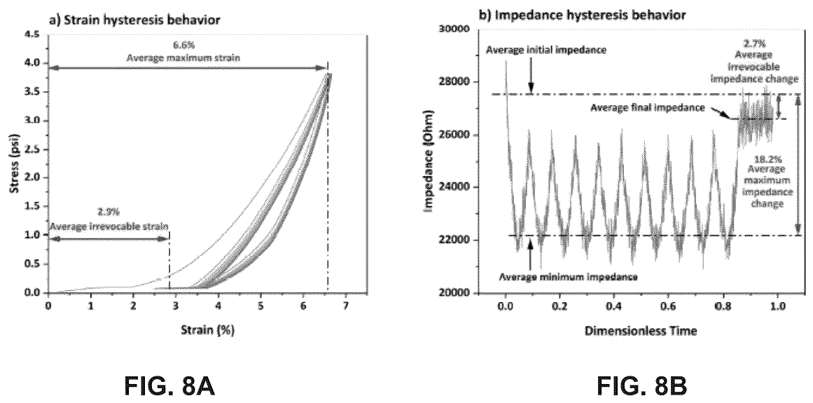

Impedance and compaction results were obtained at several temperatures and pressures. Membrane compaction is observed during six-stepwise pressure increases (FIG. 8). During each step, impedance decreases (and compaction increases). When pressure is exerted on a polymeric material, the material undergoes deformation (i.e., compaction) to absorb the impact energy and offer resistance. This deformation is likely due to polymer fiber and nanocomposite deformation and/or destruction of the crystal structure. The impedance decrease between the first point of a new step and the last point of the previous step represents instant compaction. As shown in FIG. 8, the initial instant compaction is high (98% of total compaction), and the subsequent instant compaction values have a decreasing trend (from 83 to 67% of total compaction). This trend signifies that the membrane initially has the capacity to deform significantly to offset the applied pressure but as pressure increases, irreversible damage may cause irrevocable compaction of the membrane. After the sixth step increase in pressure, the membrane is given a chance to recover. The membrane only partially recovers with a final irrevocable compaction of 16%. After the membrane's instant response to compaction, the membrane deforms more gradually as pressure continues; this time-dependent deformation is referred to as creep.

Membrane creep (and recovery) is observed under constant pressure. Returning to FIG. 8, the increasing contribution of creep to total compaction (from 2.3 to 33%) over the six step increases indicates that the role of creep on membrane compaction increases significantly with pressure. The increasing contribution of creep combined with the decreasing contribution of instant compaction results in the creep/instant compaction ratio increasing from 2.4 to 49% over the six step increases.

The strain hysteresis of the membrane detected by DMA is shown in FIG. 8A. After repeated loading and unloading of (4 psi) stress, the average maximum strain is 6.6%. Additionally, the average irrevocable strain is 2.9%. For the same experiments, the impedance hysteresis detected by EIS is shown in FIG. 8B. By subtracting the average minimum impedance from the average initial impedance, the average maximum impedance difference is 18%. Furthermore, when the average final impedance is subtracted from the average initial impedance, the average irrevocable impedance is 2.7%.

Comparison of the impedance hysteresis with the strain hysteresis allows for in situ method validation. The significant difference between the average maximum impedance difference (18%) and the average maximum strain (6.6%) is not unexpected, because of the inherent detection limitation of the mechanical analyzer. Precise control of the clamp is challenging when membranes with low stiffness and thickness are compressed; this leads to a discrepancy in the maximum strain measured during thin-film compaction. On the other hand, a comparison of the average irrevocable impedance (2.7%) with the average irrevocable strain (2.9%) results in a low percent difference (approximately 7%). During the recovery phase, no external force is applied to the clamp, meaning the strain measurements solely represent the membrane properties. Therefore, the matched average irrevocable strain and average irrecoverable impedance data are expected since both values describe the same membrane hysteresis. Thus, the comparison of irrevocable impedance from EIS with irrevocable strain from DMA provides in situ validation of the novel detection method.

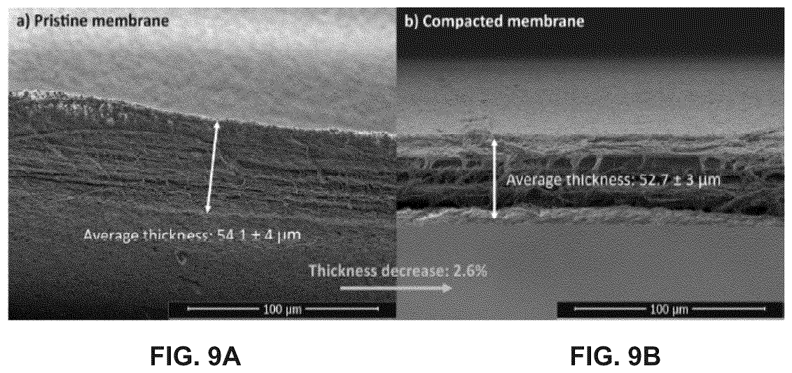

The average thickness of the pristine membrane used in this study is 54.1±4 μm (see FIG. 9A), and the average thickness of the compacted membrane, imaged in a fully recovered state, is 52.7±3 μm (see FIG. 9B). The thickness percent difference between the compacted and pristine membranes is 2.6% or, in other words, the membrane is irrevocably compacted by 2.6%. This percent difference is very similar to the irrevocable compaction values determined by the hysteresis tests (i.e., an irrevocable strain of 2.9% with an approximately 12% difference and an irrevocable impedance of 2.7% with an approximately 4% difference).

### Experiment #2

Nanofiltration (NF) and reverse osmosis (RO) membranes were used in this experiment. The NF270 membrane (DuPont Water Solutions, Wilmington, Delaware, USA) was a thin-film composite NF membrane comprising a polyamide (PA) selective layer above a microporous polysulfone (PSf) support layer, which was reinforced with a polyester (PE) nonwoven backing layer. The SP475 membrane (SUEZ Group, Paris, France) was an RO membrane comprising the same three (PA-PSf-PE) layers.

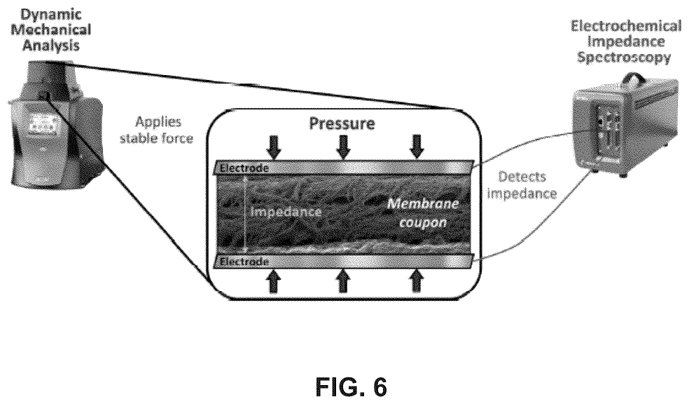

The exemplary measurement system (see FIGS. 1A-1B and FIG. 6) comprising a mechanical analyzer and a potentiostat was upgraded to measure compaction and recovery of membranes at higher pressures. The upgraded system utilized compaction clamps (TA Instruments, New Castle, Delaware, USA) and 3 mm CNC lathe-carved electrodes that provided measurement at pressures up to 330 psi. Similar to a previous study [8], a cross-material impedance scanning frequency of 100 KHz and a constant temperature of 25° C. were used for the experiment.

For the experiment, a 6 by 10 mm sample of the membrane was placed between the electrodes in the compressive clamps of the mechanical analyzer. A preload pressure of 1 psi was applied, and initial impedance ($20 in Ohms) was measured. A series of short-term, creep-and-recovery, and hysteresis experiments were performed. Final impedance (Ω_{f} in Ohms) was used to calculate the impedance percent difference (%) and compaction (%) according to Equation 4.

$$\begin{matrix}compaction = impedance percent difference \\ = \frac{{Ω}_{0} - {Ω}_{f}}{{Ω}_{0}} \times 100 \%\end{matrix} \qquad ( 4 )$$

In a series of short-term compressive experiments, impedance was measured over time while 80 and 300 psi pressures were applied to the NF and RO membranes for 10 min each. Each experiment was repeated four times, and the average of the final impedance values was used in Equation 4.

Short-term compressive experiments were also performed on RO membrane samples that were age-accelerated using ultraviolet (UV) radiation [35-38]. UV radiation can fracture/break the molecular structure of certain polymeric bonds (e.g., the C—O bond); the changes in the material's mechanical properties can shorten the fatigue process experienced during long-term operation and maintenance. To accelerate aging, pristine RO membrane samples were placed inside a self-fabricated UV chamber and exposed to a 4 W UV source (UVP UVGL-25, Analytik Jena, Upland, California, USA) for 4, 6, 24, 48, and 72 h. A wavelength of 365 nm was selected based on ASTM G151-19 [37]. The age-accelerated membrane samples were then placed in the compressive clamp and subjected to short-term compressive measurements with 300 psi applied pressure.

Creep-and-recovery experiments were conducted with constant pressure following ASTM E139 [39]. In the creep-and-recovery experiments, a pressure (80 psi) for the NF membrane and 200 psi for the RO membrane was applied for 8 h. After that, the pressure was released (dropped to 1 psi) for a 16 h recovery period. The creep-and-recovery cycle was repeated seven times. The average initial and recovered impedance values were used to calculate the average irrevocable compaction for each cycle. Increasing irrevocable compaction indicated the development of mem-brane fatigue.

Creep-and-recovery experiments were also conducted with incrementally increasing pressure. In the creep-and-recovery experiments, a pressure was incrementally increased from 1 to 80 psi at 10 psi intervals (i.e., 1, 10, 20, . . . , 80 psi) for the NF membrane. For the RO membrane, the pressure was increased from 80 to 150 psi at 10 psi intervals (i.e., 80, 90, . . . , 150 psi) and from 150 to 250 psi at 50 psi intervals (i.e., 150, 200, and 250 psi). At each step, the pressure was kept constant for 1 h. After the last hour at 80 psi for the NF membrane and 250 psi for the RO membrane, the pressure was released (dropped to 1 psi) for a 1 h recovery period. The average initial and final impedance values were used to calculate the average irrevocable compaction. Instantaneous compaction (θ in %) was calculated as the difference between the impedance at the last point of the previous pressure step and the impedance at the first point of the current pressure step; compaction due to creep (ε in %) was calculated as the change in impedance from the beginning to the end of each pressure step. The creep/instantaneous compaction ratio (φ) was calculated to assess the importance of creep compared to instantaneous compaction [8] per Equation 5.

$$φ = \frac{ε}{θ} \qquad ( 5 )$$

Observations of φ over cycles showed the increasing role of creep; increasing q indicated the development of membrane fatigue.

Hysteresis experiments were conducted using a pressure-sweeping approach with a final pressure of 80 psi for the NF membrane and 200 psi for the RO membrane. For the NF membrane, pressure was increased from 0 to 80 psi at a ramping rate of 12 psi min⁻¹, and immediately thereafter, the pressure was decreased back to 1 psi at a buckling rate of 12 psi min⁻¹. For the RO membrane, the pressure was increased from 1 to 200 psi at a ramping rate of 30 psi min⁻¹, and immediately thereafter, the pressure was decreased back to 1 psi at a buckling rate of 30 psi min⁻¹. For both membranes, strain, and impedance were measured as the pressure was increased to the maximum and decreased back to 1 psi. The ramping-and-buckling cycle was repeated 10 times. The average maximum impedance difference was calculated by subtracting the average initial impedance from the average minimum impedance values (at maximum pressure). The average of the final strain values was calculated and taken as the average irrevocable strain of the membrane. Increasing average irrevocable strain and increasing average maximum strain indicated the development of membrane fatigue.

After a membrane sample was removed from the compressive clamps, it was prepared for SEM imaging using the cryo-snap freeze-fracture method of Ferlita et al [40]. The fractured samples were sputter-coated with Pt/Pd for 45 s and SEM images were obtained using a scanning electron microscope (Nova NanoSEM 450, FEI, Hillsboro, Oregon, USA). ImageJ software (version 1.51j8, National Institutes of Health, Bethesda, MD, USA) was used to determine the thickness of the entire membrane and the thicknesses of the individual membrane layers in six locations on each sample. The average thickness of the pristine and compacted membrane or membrane layer (d_{c} in μm) was calculated from the six values. Two additional SEM images were measured to ensure the sample shown is statistically representative. Using the average thickness of the pristine membrane or membrane layer (dₚ in μm), thickness percent difference (%) and compaction (%) were calculated according to Equation 6.

$$\begin{matrix}compaction = thickness percent difference \\ = \frac{{d}_{p} - {d}_{c}}{{d}_{p}} \times 100 \%\end{matrix} \qquad ( 6 )$$

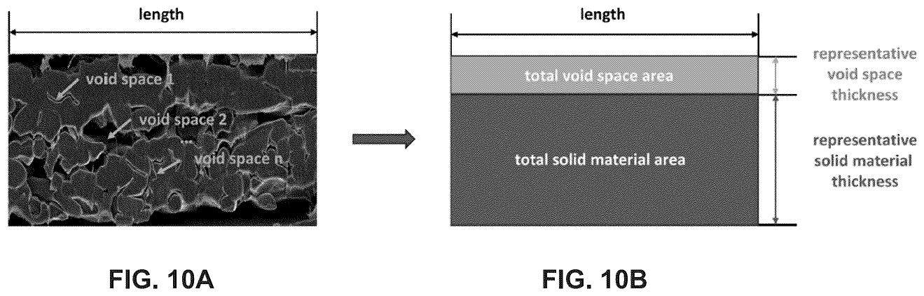

Cross-sectional SEM images were also used to identify and quantify the area occupied by void spaces in the PE backing layer. Void spaces cannot be identified in the PSf support layer. FIG. 10A shows void spaces in the PE backing layer (labeled as “void space 1, void space 2, . . . , void space n”). By representing the void spaces as polygons, their areas were calculated and summed for a total void space area. Subtracting the total void space area from the PE backing layer area resulted in the total solid material area, shown as rectangle areas in FIG. 10B. Then, using the SEM image length (equal to 345 μm), a representative void space thickness and representative solid material thickness were determined.

Tensile tests were performed using film clamps (TA Instruments) instead of compressive clamps in the mechanical analyzer. Similar to compressive testing, a preload pressure of 1 psi was applied, and initial deformation (X₀ in %) was measured. Then, tensile experiments were performed, whereby stress was measured over time while a pressure of 80 psi was applied to the NF membrane and 300 psi was applied to the RO membrane for 5 minutes each. Each experiment was repeated four times, and the average of the final stress values (X_{f} in %) was used to calculate elongation (%) according to Equation 7.

$$elongation = ( {X}_{f} - {X}_{0} ) \times 100 \% \qquad ( 7 )$$

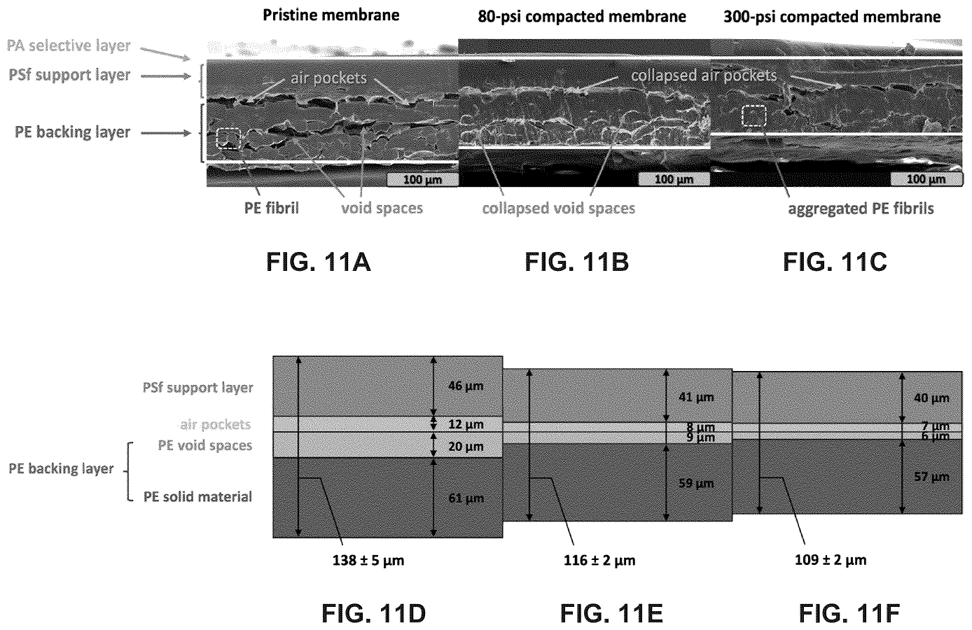

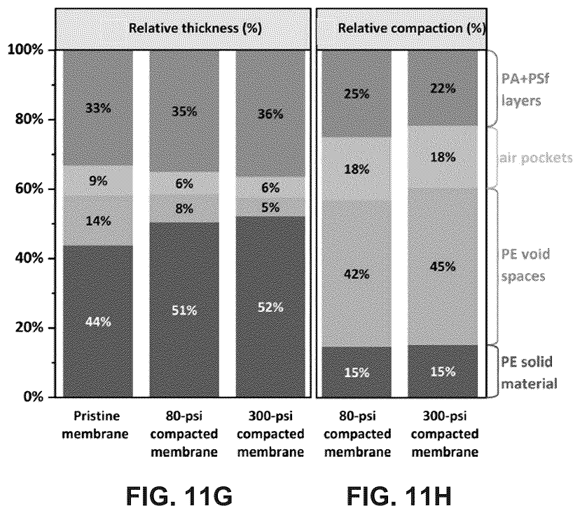

FIGS. 11A-11C shows the SEM images of the pristine and compacted NF membrane. After being subjected to pressures of approximately 80 psi (see FIG. 11B) and 300 psi (see FIG. 11C), total membrane thickness and the void space in the PE backing layer decreased. The PE fibrils distinguished in the pristine membrane (see FIG. 11A) were aggregated and no longer visible in the compacted membranes (see FIGS. 11B-11C). Based on Gustafson et al. [7], the PE fibrils may have widened, flattened, and aggregated. Upon compaction—especially at 300 psi (see FIG. 11C)—the PE solid materials became packed.

Air pockets were observed clearly in the SEM image of the pristine membrane (see FIG. 11A). Different from the term “void spaces” used for voids within the backing layer, the term “air pockets” was used for the void spaces between the support and backing layers. Although visible in SEM images in the previous studies (e.g., [41], [42]), the air pockets were not discussed in the previous studies. The air pockets can be due to the incomplete merging of the PSf support layer when coated over the previously cured PE backing layer during membrane fabrication [21]. Upon compaction—especially at 300 psi (see FIG. 11C)—the air pockets collapsed and were less visible.

FIGS. 11D-11F show the thickness values of the four main layers/components (e.g., the PSf support layer, air pockets, PE void spaces, and PE solid material) corresponding to the SEM images. Because the thickness of the PA selective layer was on the nm scale, the PA selective layer was not shown in FIGS. 11D-11F. The thickness of the PE void spaces was distinguished from the thickness of the PE solid material using the above-discussed short-term compressive method. The same method was also used to quantify the thickness of the air pockets. Comparing results at the two applied pressures (i.e., comparing FIGS. 11E and 11F), the membrane layer/component that underwent more compaction at the higher pressure was the PE void spaces. Total membrane thickness decreased by 22 μm (19%) at 80 psi applied pressure and 29 μm (22%) at 300 psi applied pressure.

As shown in FIG. 11G, the thickness of each membrane layer/component was determined by dividing the thickness of each layer/component by the total membrane thickness. Thickness values for the compacted membranes were normalized by dividing by the total compacted membrane thickness. The contributions of the PSf support layer and the PE solid material to total membrane thickness increased with compaction and the contributions of the air pockets and PE void spaces decreased. An increase in contribution indicated that the component thickness was increasing at a slower rate than the total membrane thickness, meaning that the thickness of these layers/components decreased less than the entire membrane. A decrease in thickness contribution indicated the opposite, meaning that the thickness of these layers/components decreased more than the entire membrane.

As shown in FIG. 11H, the relative compaction of each layer/component was determined by dividing compaction values for each layer/component by total membrane compaction. The relative compaction of the layers/components was similar for 80- and 300 psi applied pressure. The greatest relative compaction (up to 45%) occurred in the PE void spaces, which only accounted for 14% of the total pristine membrane thickness. The combined compaction of the PE void spaces and the air pockets accounted for over 60% of total membrane compaction under 300 psi applied pressure. After undergoing 18% relative compaction, the air pockets were significant and cannot be ignored.

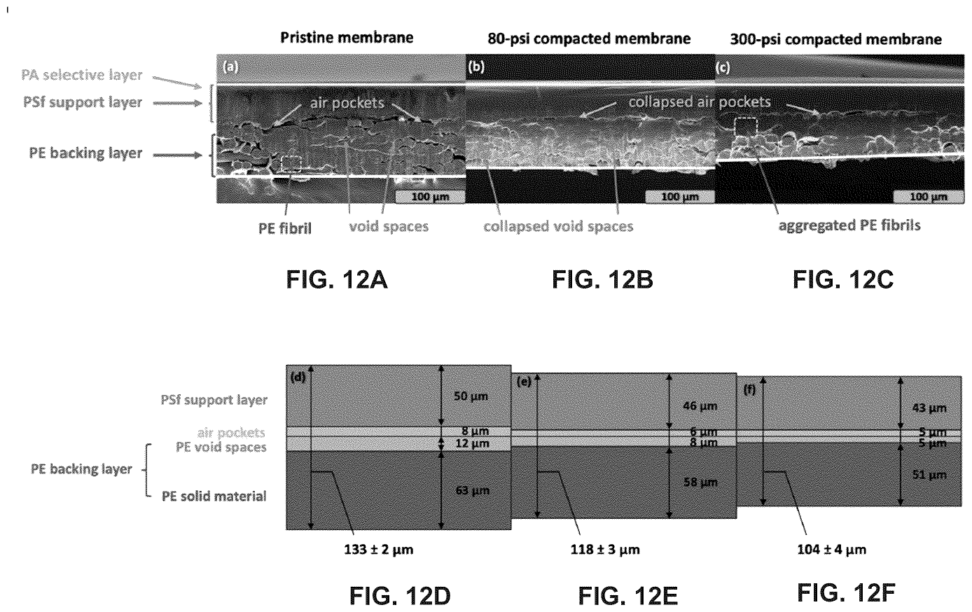

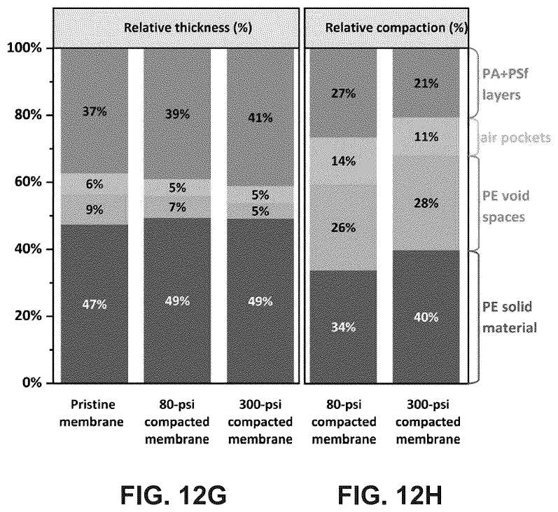

FIGS. 12A-12C show the SEM images of the pristine and compacted RO membrane. Compared to the pristine NF membrane in FIG. 11A, the pristine RO membrane (see FIG. 12A) appeared denser with fewer void spaces. Similar to the NF membrane, the air pockets observed clearly in the pristine membrane were collapsed and less visible—especially at 300 psi (see FIG. 12C). The PE fibrils that can be distinguished in the pristine membrane (see FIG. 12A) were aggregated and no longer visible in the compacted membrane (FIGS. 12B-12C). Upon compaction—especially at 300 psi (see FIG. 11C)—the PE solid materials were packed.

FIGS. 12D-12F show the thickness values of the four main layers/components. Compared to the pristine NF membrane (see FIG. 11D), the pristine RO membrane (see FIG. 12D) had smaller air pockets and fewer PE void spaces. All layers/components of the RO membrane underwent more compaction at 300 psi (see FIG. 12C) than at 80 psi (see FIG. 12B). Total membrane thickness decreased by 15 μm (13%) at 80 psi applied pressure and 29 μm (21%) at 300 psi applied pressures.

As shown in FIG. 12G, results were similar to those for the NF membrane in that the thicknesses of the PSf support layer and the PE solid material decreased less than the entire membrane, and the thicknesses of the air pockets and PE void spaces decreased more than the entire membrane. As shown in FIG. 12H, the greatest relative compaction (up to 40%) occurred in the PE solid material, accounting for 47% of the total pristine membrane thickness. The ability of the solid material to compact more at 300 psi than at 80 psi was unexpected. Also, at 300 psi, more relative compaction occurred in the PE void spaces than in the PSf support layer (28% compared to 21%), while the PSf support layer accounted for 41% of the total compacted membrane thickness and the PE void spaces only accounted for 5%. The decrease in the relative compaction of the air pockets (from 14% to 11%) suggested that the air pockets were fully compacted at 80 psi and did not undergo further compaction at 300 psi. At the higher applied pressure of 300 psi, there was no additional relative compaction of the combined air pockets and PE void spaces, even though there was 8% greater total membrane compaction.

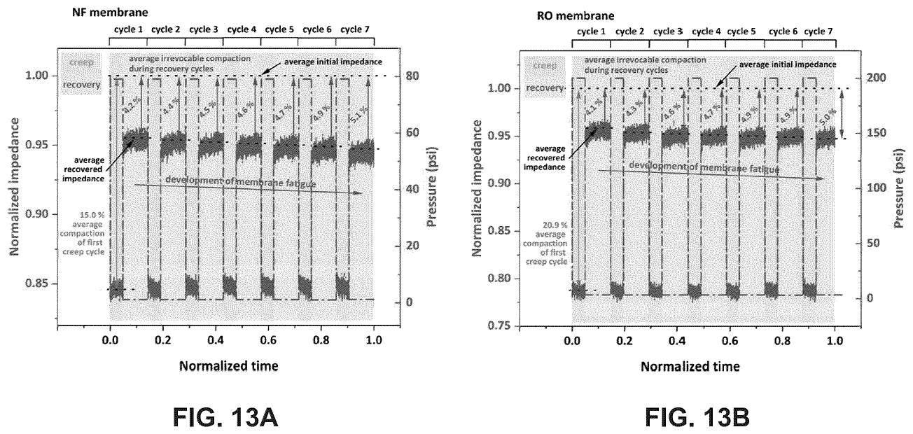

FIG. 13 shows NF and RO membranes across seven creep-and-recovery cycles of operation. For the NF membrane (see FIG. 13A), the membrane compacted 15.0% and recovered 10.8% in the first cycle; the result was 4.2% irrevocable compaction. Because the RO membrane (see FIG. 13B) was tested under higher pressure (200 psi), greater membrane compaction in the first cycle (20.9%) was observed than that in the NF membrane. Over the subsequent cycles for both membranes, irrevocable compaction showed an increasing trend, indicating that the membranes experienced greater permanent deformation and morphological changes. This trend also pointed to the gradual development of membrane fatigue.

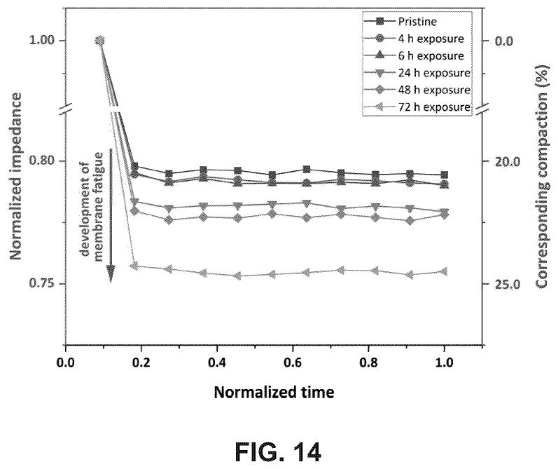

Due to equipment limitations in holding precise forces over longer time periods, the test duration was limited to seven cycles (equivalent to 168 h) for each membrane sample. Compressive experiments were also performed on age-accelerated RO membrane samples to understand the effect of pressure on membrane compaction over longer durations. As shown in FIG. 14, the pristine RO membrane underwent 20.6% average compaction, consistent with the results shown in FIG. 13B (20.9% average compaction). For the aged membrane samples, compaction increased with the duration for which the samples were exposed to UV radiation. Thus, aging the membrane samples made them more susceptible to the development of membrane fatigue.

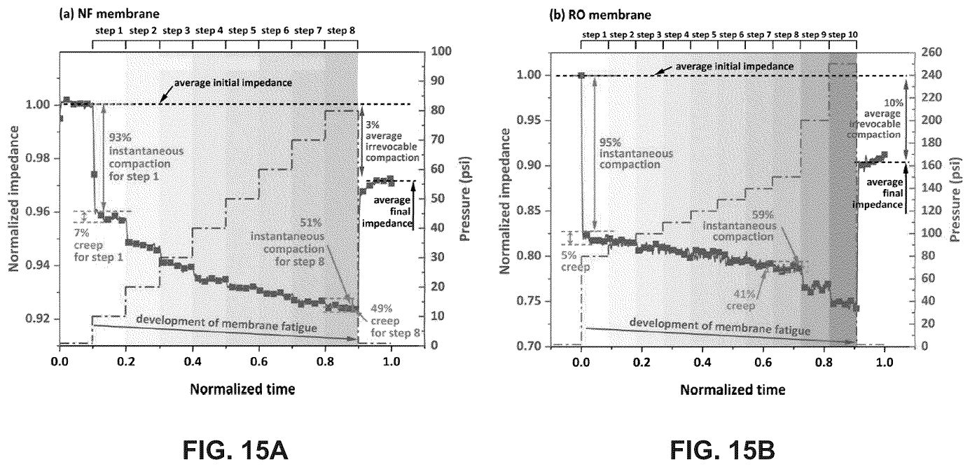

FIG. 15A shows how instantaneous compaction and creep contributed to total NF membrane compaction during incremental pressure increases. The initial high decrease in impedance in step 1 indicated instantaneous compaction that accounted for 93% of the total compaction in this step. In subsequent steps, the contribution of instantaneous compaction to total compaction decreases (reaching 51% in step 8). The high instantaneous compaction in step 1 was because the free-standing membrane fibrils had more degrees of freedom and were more susceptible to deformation (i.e., compaction) when pressure was first applied to the membrane. Then, when pressure was constant, impedance decreased due to creep, accounting only for 7% of compaction in step 1. As the pressure increased in subsequent steps, the membrane fibrils broke and aggregated to counterbalance the applied pressure, which can lead to membrane collapse [13], [18], [19]. As the packed membrane became denser, membrane stiffness increased and provided greater resistance to pressure than the pristine membrane provided; this was referred to as “the stiffening effect”, which was discussed in previous studies (e.g., [43], [44]). In subsequent steps, the contribution of creep to total compaction increased from 7% to 49%, as shown in Table 1. The increasing contribution of creep and the decreasing contribution of instant compaction resulted in an increase in the creep/instant compaction ratio from 8% to 94% from steps 1 to 8. The time-dependent deformation associated with creep indicated the development of membrane fatigue.

TABLE 1

| Compaction | | | | | | | | |
|---|---|---|---|---|---|---|---|---|
| percentage (%) | Step 1 | Step 2 | Step 3 | Step 4 | Step 5 | Step 6 | Step 7 | Step 8 |
| Instantaneous | 93 | 75 | 70 | 70 | 69 | 55 | 54 | 51 |
| Creep | 7 | 25 | 30 | 30 | 31 | 45 | 46 | 49 |
| φ | 8 | 34 | 42 | 44 | 45 | 80 | 85 | 94 |

FIG. 15B shows the results for the RO membrane, including two additional steps (steps 9 and 10) at a higher pressure-interval (50 psi/step). Similar to the NF membrane, the instantaneous compaction was higher in step 1 than in subsequent steps. From steps 1 to 8, instantaneous compaction decreased from 95% to 59% of the total compaction. At the same time, creep increased from 5% to 41% of the total compaction as shown in Table 2. Consequently, the creep/instantaneous compaction ratio increased from 5% to 68% from steps 1 to 8.

TABLE 2

| Compaction | Step | Step | Step | Step | Step | Step | Step | Step | Step | Step |
|---|---|---|---|---|---|---|---|---|---|---|
| percentage (%) | 1 | 2 | 3 | 4 | 5 | 6 | 7 | 8 | 9 | 10 |
| Instantaneous | 95 | 85 | 82 | 77 | 71 | 57 | 59 | 59 | 88 | 83 |
| Creep | 5 | 15 | 18 | 23 | 29 | 44 | 41 | 41 | 12 | 17 |
| φ | 5 | 18 | 22 | 30 | 41 | 76 | 69 | 68 | 13 | 20 |

The average irrevocable compaction of the RO membrane (10%) was higher than that observed for the NF membrane (3%). This indicated that the RO membrane experienced greater permanent deformation (and greater morpho-logical changes) when it was operated under an operating pressure of 300 psi than the NF membrane when it was operated under an operating pressure of 80 psi.

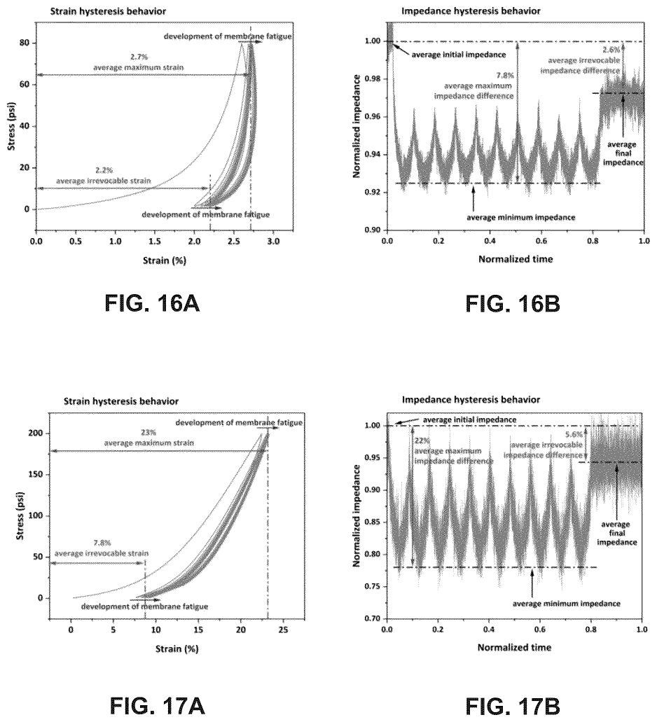

FIG. 16A shows the strain hysteresis behavior of the NF membrane detected by the mechanical analyzer. After repeated loading and unloading of 80 psi stress, the average maximum strain was 2.7%, and the average irrevocable strain was 2.2%. FIG. 16B shows the impedance hysteresis detected by the potentiostat. By subtracting the average minimum impedance from the average initial impedance, the average maximum impedance change was 7.8%. Furthermore, when the average final impedance was subtracted from the average initial impedance, the average irrevocable impedance was 2.6%. Comparison of the average irrevocable strain (2.2%) with the average irrevocable impedance difference (2.6%) provided in situ method validation. Also, the increases in the average maximum strain and average irrevocable strain for each ramping and buckling cycle indicated the development of membrane fatigue.

FIG. 17 shows the strain and impedance hysteresis behaviors of the RO membrane. Comparison of the average irrevocable strain (7.8%) with the average irrevocable impedance difference (5.6%) provided in situ method validation. These two values differed due to measurement noise under high pressures, indicating a gradual increase in the development of membrane fatigue.

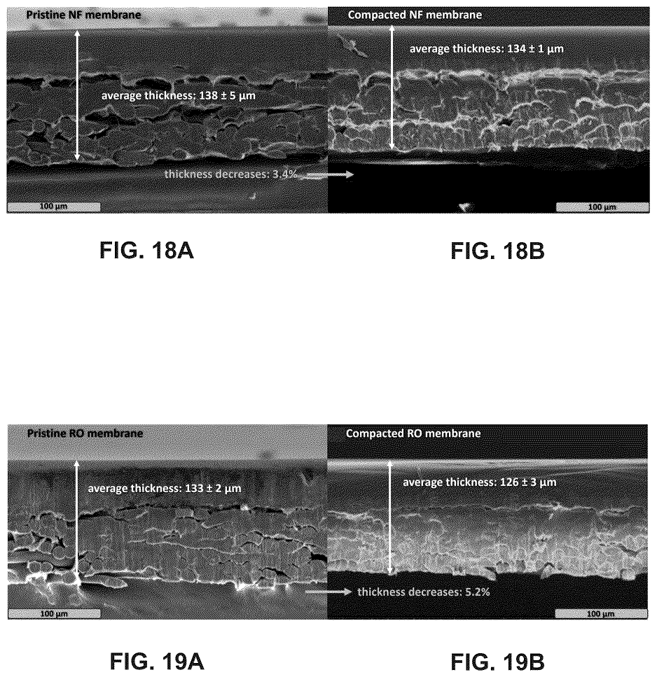

From SEM images, the thickness percent difference between the compacted and pristine NF membrane was 3.4% (see FIG. 18), and the thickness percent difference between the compacted and pristine RO membranes was 5.2% (see FIG. 19). These values were comparable with the average irrevocable strain of the NF membrane (2.2%) in FIG. 16A and the average irrevocable strain of the RO membrane (7.8%) in FIG. 17A.

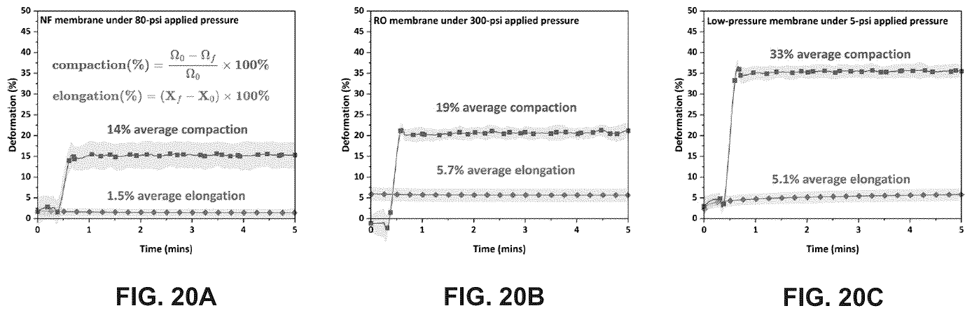

FIGS. 20A-20B show compaction measured by compressive tests and elongation measured by tensile tests for the NF and RO membranes. FIG. 20C shows compaction and elongation data for a single-layer, homogeneous membrane (the same membrane used in Ding et al. [8]). For all membranes, the tensile tests underestimated compaction. Tensile testing on the single-layer, homogeneous membrane underestimated compaction even more than for the multilayer, heterogeneous membranes. Given homogeneous membranes' uniform material properties and consistent structural composition, tensile testing results can more accurately represent compaction. One reason why tensile (elongation) strain should not be compared with or used to represent compressive (compaction) strain was that during tensile and compressive testing, the membrane experienced different transverse compaction strain and longitudinal elongation strain in all material directions, which was governed by the material's properties (e.g., Poisson's ratio [18], [45]). The material's compressive (compaction) strain in the thickness-decreasing direction cannot be represented by the tensile (elongation) strain in the length-increasing direction; instead, a deformation tensor should be used to describe the material's deformation in all material directions [45]. The stiffening effect may be another reason that tensile testing underestimated membrane compaction, especially for thin-film composite membranes with one dimension (the thickness) less than the other two dimensions [45], [46]. As a result, the stiffening effect in the tensile (thickness-increasing) direction caused the polymer chains in the membrane to straighten out in the direction of the force to occur more rapidly and led to higher material resistance than it did in the compressive (thickness-decreasing) direction [18], [45].

### Discussion

Membrane compaction does not solely occur in the support/backing layer of the multilayer NF and RO membranes tested. The air pockets in both membranes, which have not been discussed in previous studies, play a crucial role in membrane compaction. For the NF membrane, the majority of compaction occurs in the void spaces of the backing layer, while for the RO membrane, the majority of compaction occurs in the solid material of the backing layer.

Several trends in the experimental data can be used to characterize the development of membrane fatigue during operation (i.e., membrane fatigue induced by transmembrane pressure (TMP)), including the increase in average irrevocable compaction values in creep-and-recovery experiments, the increase in creep/instantaneous compaction ratios (φ), and the increase in average maximum strains and average irrevocable strains in hysteresis experiments. Furthermore, susceptibility to membrane fatigue can increase with membrane age. Tensile testing does not accurately represent compaction for membranes. The exemplary system can only characterize membrane compaction in a dry condition and at pressures up to and including 330 psi.

### CONCLUSION

The disclosed experimental results show that the disclosed systems and methods provide the capability of detecting compaction, even subtle deformation, caused by creep. Stepwise pressure increases that induced membrane compaction due to both instant compaction and creep-enabled differentiation of the contribution of creep to total compaction. The initial instant compaction contributed more to total compaction than the subsequent instant compaction.

Comparison of hysteresis using EIS with DMA provided an in-situ validation of the method. The average irrevocable strain and average irrevocable impedance were in close agreement, further validating the proposed detection method. Ex situ validation was provided by using thickness measurements from SEM images.

Applications of the disclosed systems and methods include but are not limited to wastewater treatment applications; water desalination and water reuse, especially for direct potable reuse; food and beverage industries (e.g., breweries, beverage factories, etc.); aircraft and spacecraft; battery and energy storage equipment with membranes; medical aspect e.g., artificial organ (heart, kidney, liver, etc.) and vessel; addressing military needs through specialized applications, like the development of rapid deployment vanguard water purification equipment and front base wastewater treatment systems; and, monitoring the status of the protective suit for biowarfare.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The following patents, applications, and publications, as listed below and throughout this document, are hereby incorporated by reference in their entirety herein.
[1] Elimelech, M.; Phillip, W. A. The future of seawater desalination: energy, technology, and the environment. Science 2011, 333 (6043), 712-717.
[2] Warsinger, D. M.; Chakraborty, S.; Tow, E. W.; Plumlee, M. H.; Bellona, C.; Loutatidou, S.; Karimi, L.; Mikelonis, A. M.; Achilli, A.; Ghassemi, A.; et al. A review of polymeric membranes and processes for potable water reuse. Prog. Polym. Sci. 2018, 81, 209-237.
[3] Wei, X.; Sanders, K. T.; Childress, A. E. Reclaiming wastewater with increasing salinity for potable water reuse: water recovery and energy consumption during reverse osmosis desalination. Desalination 2021, 520, 115316.
[4] Plata, S. L.; Devenport, C. L.; Miara, A.; Sitterley, K. A.; Evans, A.; Talmadge, M.; Van Allsburg, K. M.; Kurup, P.; Cox, J.; Kerber, S.; et al. Zero liquid discharge and water reuse in recirculating cooling towers at power facilities: review and case study analysis. ACS ES&T Eng. 2022, 2 (3), 508-525.
[5] Goh, P.; Wong, K.; Ismail, A. Membrane technology: A versatile tool for saline wastewater treatment and resource recovery. Desalination 2022, 521, 115377.
[6] Davenport, D. M.; Ritt, C. L.; Verbeke, R.; Dickmann, M.; Egger, W.; Vankelecom, I. F.; Elimelech, M. Thin film composite membrane compaction in high-pressure reverse osmosis. J. Membr. Sci. 2020, 610, 118268.
[7] Gustafson, R. D.; McGaughey, A. L.; Ding, W.; McVety, S. C.; Childress, A. E. Morphological changes and creep recovery behavior of expanded polytetrafluoroethylene (ePTFE) membranes used for membrane distillation. J. Membr. Sci. 2019, 584, 236-245.
[8] Ding, W.; Ma, K.; Childress, A. E. A Novel Method to Quantify Real-Time Compaction of Water Treatment Membranes. Environ. Sci. Technol. Lett. 2023, 10, 955-960.
[9] Pendergast, M. T. M.; Nygaard, J. M.; Ghosh, A. K.; Hoek, E. M. Using nanocomposite materials technology to understand and control reverse osmosis membrane compaction. Desalination 2010, 261 (3), 255-263.
[10] Lee, J.; Lim, Y. J. On the control strategy to improve the salt rejection of a thin-film composite reverse osmosis membrane. A ppl. Sci. 2021, 11 (16), 7619.
[11] Stade, S.; Kallioinen, M.; Mikkola, A.; Tuuva, T.; Mänttäri, M. Reversible and irreversible compaction of ultrafiltration membranes. Sep. Purif. Technol. 2013, 118, 127-134.
[12] Crossley, O. P.; Thorpe, R. B.; Peus, D.; Lee, J. The effect of salinity on the pressure susceptibility of the NF270 membrane. Desalination 2023, 564, 116804.
[13] Brownell, M.; Nair, A. K. Deformation mechanisms of polytetrafluoroethylene at the nano- and microscales. Phys. Chem. Chem. Phys. 2019, 21 (1), 490-503.
[14] Zhao, Y.; Lai, G. S.; Chong, J. Y.; Wang, R. Dissecting the structure-compaction-performance relationship of thin-film composite polyamide membranes with different structure features. J. Membr. Sci. 2022, 654, 120553.
[15] Rao, G.; Hiibel, S. R.; A chilli, A.; Childress, A. E. Factors contributing to flux improvement in vacuum-enhanced direct contact membrane distillation. Desalination 2015, 367, 197-205.
[16] Persson, K. M.; Gekas, V.; Trägårdh, G. Study of membrane compaction and its influence on ultrafiltration water permeability. J. Membr. Sci. 1995, 100 (2), 155-162.
[17] McGaughey, A. L.; Childress, A. E. Wetting indicators, modes, and trade-offs in membrane distillation. J. Membr. Sci. 2022, 642, 119947.
[18] Young, R. J.; Lovell, P. A. Introduction to Polymers; CRC Press, 2011.
[19] Young, R.; Eichhorn, S. Deformation mechanisms in polymer fibres and nanocomposites. Polymer 2007, 48 (1), 2-18.
[20] Zhang, J.; Gray, S. Effect of applied pressure on performance of PTFE membrane in DCM D. J. Membr. Sci. 2011, 369 (1-2), 514-525.
[21] Wu, J.; He, J.; Quezada-Renteria, J. A.; Le, J.; Au, K.; Guo, K.; Xiao, M.; Wang, X.; Dlamini, D.; Fan, H.; et al. Polyamide Reverse Osmosis Membrane Compaction and Relaxation: Mechanisms and Implications for Desalination Performance. J. Membr. Sci. 2024, 706, 122893.
[22] Wu, J.; Jung, B.; Anvari, A.; Im, S.; Anderson, M.; Zheng, X.; Jassby, D.; Kaner, R. B.; Dlamini, D.; Edalat, A.; et al. Reverse osmosis membrane compaction and embossing at ultra-high pressure operation. Desalination 2022, 537, 115875.
[23] Gustafson, R. D.; Hiibel, S. R.; Childress, A. E. Membrane distillation driven by intermittent and variable-temperature waste heat: System arrangements for water production and heat storage. Desalination 2018, 448, 49-59.
[24] A ghajani, M.; Maruf, S. H.; Wang, M.; Yoshimura, J.; Pichorim, G.; Greenberg, A.; Ding, Y. Relationship between permeation and deformation for porous membranes. J. Membr. Sci. 2017, 526, 293-300.
[25] A ghajani, M.; Wang, M.; Cox, L. M.; Killgore, J. P.; Greenberg, A. R.; Ding, Y. Influence of support-layer deformation on the intrinsic resistance of thin film composite membranes. J. Membr. Sci. 2018, 567, 49-57.
[26] (Instruments, T Dynamic Mechanical Analysis Basic Theory & Applications Training Day 1.2020.https://www.tainstruments.com/wp-content/uploads/2020_DMA_Online_Training_Part_1.pdf (accessed May 15, 2023).
[27] Liu, Z.; Wang, H.; Li, Y.; Wang, X.; Selvadurai, A. P. S. Triaxial Compressive Strength, Failure, and Rockburst Potential of Granite Under High-Stress and Ground-Temperature Coupled Conditions. Rock Mech. Rock Eng. 2023, 56 (2), 911-932.
[28] Fan, H.; Elimelech, M.; Biesheuvel, P. Theory of expansion and compression of polymeric materials: Implications for membrane solvent flow under compaction. J. Membr. Sci. 2024, 697, 122576.
[29] Lim, Y. J.; Nadzri, N.; Lai, G. S.; Wang, R. Demystifying the compaction effects of TFC polyamide membranes in the desalination of hypersaline brine via high-pressure RO. J. Membr. Sci. 2024, 707, 122950.
[30] Xu, C.; Wang, Z.; Hu, Y.; Chen, Y. Thin-Film Composite Membrane Compaction: Exploring the Interplay among Support Compressive Modulus, Structural Characteristics, and Overall Trans-port Efficiency. Environ. Sci. Technol. 2024, 58 (19), 8587-8596.
[31] Wang, K.; Abdalla, A. A.; Khaleel, M. A.; Hilal, N.; Khraisheh, M. K. Mechanical properties of water desalination and wastewater treatment membranes. Desalination 2017, 401, 190-205.
[32] Hendry, A. W. Compression Failure Theories. In Structural Masonry; Macmillan Education: UK, 1998; pp 56-70.
[33] Kusoglu, A.; Santare, M. H.; Karlsson, A. M. Aspects of fatigue failure mechanisms in polymer fuel cell membranes. J. Polym. Sci., Part B: Polym. Phys. 2011, 49 (21), 1506-1517.
[34] Qiu, D.; Peng, L.; Lai, X.; Ni, M.; Lehnert, W. Mechanical failure and mitigation strategies for the membrane in a proton exchange membrane fuel cell. Renewable Sustainable Energy Rev. 2019, 113, 109289.
[35] ASTM. Standard Practice for Fluorescent Ultraviolet (UV) Lamp Apparatus Exposure of Plastics; ASTM, 2021.
[36] Gao, H.; Yuan, L.; Liu, G.; Gao, J. An ultraviolet light-responsive polyacrylate film with high fatigue resistance. J. Polym. Res. 2022, 29 (2), 46.
[37] ASTM. Standard Practice for Exposing Nonmetallic Materials in Accelerated Test Devices that Use Laboratory Light Sources; ASTM, 2019.
[38] Frigione, M.; Rodríguez-Prieto, A. Can accelerated aging procedures predict the long term behavior of polymers exposed to different environments? Polymers 2021, 13 (16), 2688.
[39] E139-11, A. Standard test methods for conducting creep, creep-rupture, and stress-rupture tests of metallic materials. ASTM International West Conshohocken: 2018.
[40] Ferlita, R. R.; Phipps, D.; Safarik, J.; Y eh, D. H. Cryo-snap: A simple modified freeze-fracture method for SEM imaging of membrane cross-sections. Environ. Prog. 2008, 27 (2), 204-209.
[41] Diop, S.; Diallo, M.; Diawara, C.; Cot, D. Intrinsic properties and performances of NF270 and XLE membranes for water filtration. Water Sci. Technol.: Water Supply 2011, 11 (2), 186-193.
[42] Sim, L. N.; Gu, J.; Coster, H. G.; Fane, A. G. Quantitative determination of the electrical properties of RO membranes during fouling and cleaning processes using electrical impedance spectroscopy. Desalination 2016, 379, 126-136.
[43] Zhang, Z.; Bai, P.; Xiao, Y.; Guo, Y.; Wang, Y. Conformation-Induced stiffening effect of crosslinked polymer thin films. Commun. Phys. 2023, 6 (1), 332.
[44] Carey, B. J.; Patra, P. K.; Ci, L.; Silva, G. G.; Ajayan, P. M. Observation of dynamic strain hardening in polymer nanocomposites. ACS Nano 2011, 5 (4), 2715-2722.
[45] Bonet, J.; Wood, R. D. Nonlinear Continuum Mechanics for Finite Element Analysis; Cambridge University Press, 1997.
[46] Freund, L. B.; Suresh, S. Thin Film Materials: Stress, Defect Formation and Surface Evolution; Cambridge University Press, 2004.

What is claimed:

1. A system for determining compaction of a thin film material based on measured impedance across the thin film, comprising:
a force application and measurement device, wherein force is applied to the thin film by a force application and measurement device; and
an impedance meter connected to two electrodes, with each of the electrodes located on opposite sides of the thin film,
wherein the force application and measurement device applies a precisely controlled force to the thin film, and the impedance meter detects an impedance at a set frequency which fits the materials' electrochemical properties.

2. The system of claim 1, wherein the set frequency is selected from a range starting at and including 1 kHz to 1000 kHz, including 1000 kHz.

3. The system of claim 1, wherein compaction of the thin film is determined by changes in measured impedance across the thin film over time caused by the compaction.

4. The system of claim 1, wherein force is applied to the thin film by the force application and measurement device using one or more plates that apply the force to one or both sides of the thin film.

5. The system of claim 1, wherein the force application and measurement device applies mechanical force to the thin film using one or more of hydraulics, pneumatics, motor-drive, magnetics, and electro-magnetics.

6. The system of claim 5, wherein the force application and measurement device applies mechanical force to the thin film of 330 psi, or less.

7. The system of claim 1, further comprising a computer having one or more processors and a memory, wherein the force application and measurement device and the impedance meter are connected to a computer such that the computer can transmit information to the force application and measurement device and/or the impedance meter and/or receive information transmitted from the force application and measurement device and/or the impedance meter.

8. The system of claim 7, wherein information transmitted to the force application and measurement device and/or the impedance meter from the computer include control signals for controlling the force application and measurement device and/or the impedance meter.

9. The system of claim 1, wherein the impedance meter comprises an electrochemical impedance spectroscopy (EIS) meter.

10. A method of determining a correlation between compaction and measured impedance across a thin film, comprising:
a. measuring impedance from one side of the thin film to an opposite side of the thin film in an un-compacted state;
b. applying a force to the thin film to compact the thin film;
c. measuring an impedance of the compacted thin film;
d. repeating a.-c. a plurality of times, wherein compaction of the thin film is correlated with the measured impedance; and
e. creating a table that correlates the measured impedance with a compaction value such that measured impedance across the thin film can be correlated with a level of compaction such that measured impedance across the thin film can be correlated with a level of compaction.

11. The method of claim 10, wherein the force applied to the thin film to compact the thin films is 330 psi, or less.

12. A system for monitoring compaction of a thin film, comprising:
an impedance meter connected to at least two electrodes, with each of the electrodes located on opposite sides of the thin film; and
a computing device comprising at least one or more processors and a memory, wherein the computing device is in communication with the impedance meter and where a table is stored in the memory, said table correlating impedance values with compaction, wherein said computing device;
receives an impedance value from the impedance meter, said impedance value indicating a real-time value of impedance across the thin film, and
determines a real-time compaction value of the thin film based on the impedance value received from the impedance meter and the table stored in the memory.

13. The system of claim 12, wherein the computing device causes an action to occur if the determined real-time compaction value meets or exceeds a threshold value.

14. The system of claim 13, wherein the action comprises one or more of triggering an alarm, causing a back-flow through the thin-film, diverting a fluid flow away from the thin film, and/or shutting down a system until the thin film is replaced or cleaned.

15. The system of claim 12, wherein the impedance meter comprises an electrochemical impedance spectroscopy (EIS) meter.

16. A method for monitoring compaction of a thin film, comprising:
receiving an impedance value, said impedance value indicating a real-time value of impedance across the thin film, and
determining a real-time compaction value of the thin film based on the received impedance value received from the impedance meter and a table correlating impedance values with compaction.

17. The method of claim 16, further comprising causing an action to occur if the determined real-time compaction value meets or exceeds a threshold value.

18. The method of claim 17, wherein the action comprises one or more of triggering an alarm, causing a back-flow through the thin-film, diverting a fluid flow away from the thin film, and/or shutting down a system until the thin film is replaced or cleaned.

19. The method of claim 16, wherein the impedance meter comprises an electrochemical impedance spectroscopy (EIS) meter.
